(19) United States
(12) Patent Application Publication
(10) Pub. No.: US 2010/0268363 A1
(43) Pub. Date: Oct. 21, 2010

(54) DIGITALLY-MACHINED SMC DENTAL ARTICLES

(76) Inventors: Naimul Karim, Maplewood, MN (US); Sumita B. Mitra, West St. Paul, MN (US)

Correspondence Address: 3M INNOVATIVE PROPERTIES COMPANY, PO BOX 33427, ST. PAUL, MN, 55133-3427, US

(21) Appl. No.: 12/742,114

(22) PCT Filed: Nov. 20, 2008
(86) PCT No.: PCT/US08/84150

§ 371 Date: May 10, 2010

Related U.S. Application Data
(60) Provisional application No. 60/990,675, filed on Nov. 28, 2007.

(51) Int. Cl. G05B 19/4097

(52) U.S. Cl. 700/98; 700/159

(57) ABSTRACT

A dental article is fabricated from an SMC material using three-dimensional data captured from natural dentition to guide a computer-controlled milling machine. The three-dimensional data may include scans of an original tooth structure and a prepared tooth surface to characterize all surfaces of a dental article, or certain features may be created within a computer-assisted design environment taking account of occlusion, proximal contacts, and the like. In addition the model applied to a computer-controlled milling machine may account for shrinkage of the SMC material during any post-milling curing steps in order to ensure an accurate fit to the prepared tooth surface.

### CROSS-REFERENCE TO RELATED APPLICATIONS

This application claims the benefit of U.S. Provisional Patent Application No. 60/990,675, filed Nov. 28, 2007.

### BACKGROUND

1. Field of the Invention

The invention relates to dentistry, and more particularly to applying three-dimensional scans of human dentition to mill dental articles from SMC dental mill blanks.

2. Description of the Related Art

One technique for fabricating crowns and other dental articles employs a computer-controlled milling machine to shape a mill blank into a desired end product. Most commercially available mill blanks are made of ceramic or some other material suitably hard for use in a final dental restoration, such as porcelain or micaceous ceramics. However, the manufacture of dental articles from such SMC materials may still require a number of manual steps such as designing and fitting an interim article on a physical model before fabricating a final dental article for a dental patient.

There remains a need for intraoral capture of tooth geometry in a form that can be used by a computer-controlled milling machine to fabricate dental articles from SMC materials.

### SUMMARY

A dental article is fabricated from an SMC material using three-dimensional data captured from natural dentition to guide a computer-controlled milling machine. The three-dimensional data may include scans of an original tooth structure and a prepared tooth surface to characterize all surfaces of a dental article, or certain features may be created within a computer-assisted design environment taking account of occlusion, proximal contacts, and the like. In addition the model applied to a computer-controlled milling machine may account for shrinkage of the SMC material during any post-milling curing steps in order to ensure an accurate fit to the prepared tooth surface.

In one aspect, a method disclosed herein includes providing a dental mill blank comprising a self-supporting, malleable, curable (SMC) material; scanning dentition to obtain a scan result; processing the scan result to obtain a three-dimensional digital model for controlling a digitally-controlled milling machine; fabricating a dental article from the dental mill blank using the three-dimensional digital model and the digitally-controlled milling machine; and curing the dental article to provide a cured dental article.

The method may include adjusting the three-dimensional digital model to compensate for shrinkage to the dental article during curing. Adjusting the three-dimensional digital model may include compensating for monolithic shrinkage. The method may include securing the cured dental article to a prepared tooth surface. The method may include securing the dental article to a prepared tooth surface before curing the dental article. The method may include adjusting one or more proximal contacts of the dental article before curing the dental article. Scanning dentition may include scanning a tooth surface before preparation of the surface for the dental article. The method may include creating at least one surface of the three-dimensional digital model using the scan of the tooth surface. Scanning dentition may include scanning a prepared tooth surface. The method may include creating at least one surface of the three-dimensional digital model using the scan of the prepared tooth surface. The method may include manually reshaping the dental article to obtain a desired exterior surface for the dental article. The method may include placing the cured dental article into an articulating model and adjusting an occlusal fit of the cured dental article. The method may include placing the dental article into an articulating model and adjusting an occlusal fit of the dental article before curing. The method may include partially curing the dental article to provide a partially cured dental article and manually reshaping the partially cured dental article to obtain a desired exterior shape. The dental article may include a restoration. The restoration may include a dental article selected from the group consisting of a bridge, a crown, an inlay, and an onlay. The SMC material may include a resin system with a crystalline component, a filler system, and an initiator system. The SMC material may include a resin system comprising at least one ethylenically unsaturated component and a crystalline component; greater than 60 wt-% of a filler system; and an initiator system; wherein the SMC material exhibits sufficient malleability at a temperature of about 15° C. to 38° C. The SMC material may include a polymerizable compound and an organogelator. The organogelator may be a polymerizable organogelator.

### BRIEF DESCRIPTION OF THE FIGURES

The invention and the following detailed description of certain embodiments thereof may be understood by reference to the following figures.

FIG. 1 shows a three-dimensional scanning system.

FIG. 2 shows an SMC dental mill blank.

FIG. 3 shows a computer-controlled milling machine.

FIG. 4 shows a dental article fabricated from a dental mill blank.

FIG. 5 shows a method for fabricating a dental article.

### DETAILED DESCRIPTION

Described herein are systems and methods for fabricating a dental article from an SMC dental mill blank that uses data from a three-dimensional scan of patient dentition to control operation of a computer-controlled milling machine. While the description emphasizes certain specific steps and certain types of dental articles, it will be understood that additional variations, adaptations, and combinations of the methods and systems below will be apparent to one of ordinary skill in the art, such as fabrication of dental restorations not specifically described, or use of three-dimensional scanning technologies not specifically identified, and all such variations, adaptations, and combinations are intended to fall within the scope of this disclosure. For example, while not specifically described below, it will be understood that coping or other substructure may be fabricated using the techniques described herein. As another example, the following techniques may be employed to fabricate components of a physical model used in the manual creation of a restoration or the like.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives.

Unless explicitly indicated or otherwise clear from the context, the following conventions are employed in the following disclosure, and are intended to describe the full scope of the inventive concepts herein. All numbers expressing feature sizes, amounts, and physical properties used in the specification and claims are to be understood as being modified by the term “about.” Any numerical parameters set forth in this specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. In a list, the term “or” means one or all of the listed elements or a combination of any two or more of the listed elements.

When a group is present more than once in a formula described herein, each group is “independently” selected, whether specifically stated or not. For example, when more than one M group is present in a formula, each M group is independently selected.

The terms “three-dimensional surface representation”, “digital surface representation”, “three-dimensional surface map”, and the like, as used herein, are intended to refer to any three-dimensional surface map of an object, such as a point cloud of surface data, a set of two-dimensional polygons, or any other data representing all or some of the surface of an object, as might be obtained through the capture and/or processing of three-dimensional scan data, unless a different meaning is explicitly provided or otherwise clear from the context. A “three-dimensional representation” may include any of the three-dimensional surface representations described above, as well as volumetric and other representations, unless a different meaning is explicitly provided or otherwise clear from the context.

Terms such as “digital dental model”, “digital dental impression” and the like, are intended to refer to three-dimensional representations of dental objects that may be used in various aspects of acquisition, analysis, prescription, and manufacture, unless a different meaning is otherwise provided or clear from the context. Terms such as “dental model” or “dental impression” are intended to refer to a physical model, such as a cast, printed, or otherwise fabricated physical instance of a dental object. Unless specified, the term “model”, when used alone, may refer to either or both of a physical model and a digital model.

As used herein, the term “room temperature” refers to a temperature of 20° C. to 25° C. or 22° C. to 25° C.

The term “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “dental object”, as used herein, is intended to refer broadly to subject matter specific to dentistry. This may include intraoral structures such as dentition, and more typically human dentition, such as individual teeth, quadrants, full arches, pairs of arches which may be separate or in occlusion of various types, soft tissue, and the like, as well as bones and any other supporting or surrounding structures. As used herein, the term “intraoral structures” refers to both natural structures within a mouth as described above and artificial structures such as any of the dental objects described below that might be present in the mouth. As used herein, the term dental article is intended to refer to a man-made dental object. Dental articles may include “restorations”, which may be generally understood to include components that restore the structure or function of existing dentition, such as crowns, bridges, veneers, inlays, onlays, amalgams, composites, and various substructures such as copings and the like, as well as temporary restorations for use while a permanent restoration is being fabricated. Dental articles may also include a “prosthesis” that replaces dentition with removable or permanent structures, such as dentures, partial dentures, implants, retained dentures, and the like. Dental articles may also include “appliances” used to correct, align, or otherwise temporarily or permanently adjust dentition, such as removable orthodontic appliances, surgical stents, bruxism appliances, snore guards, indirect bracket placement appliances, and the like. Dental articles may also include “hardware” affixed to dentition for an extended period, such as implant fixtures, implant abutments, orthodontic brackets, and other orthodontic components. Dental articles may also include “interim components” of dental manufacture such as dental models (full or partial), wax-ups, investment molds, and the like, as well as trays, bases, dies, and other components employed in the fabrication of restorations, prostheses, and the like. Dental objects may also be categorized as natural dental objects such as the teeth, bone, and other intraoral structures described above or as artificial dental objects (i.e., dental articles) such as the restorations, prostheses, appliances, hardware, and interim components of dental manufacture as described above. A dental article may be fabricated intraorally, extraorally, or some combination of these.

The following description emphasizes the use of self-supporting, malleable, curable (SMC) materials, also referred to herein as “hardenable compositions.” In general, an SMC material is self-supporting in the sense that the material has sufficient internal strength before curing to be formed into a desired shape that can be maintained for a period of time, such as to allow for transportation and storage. An SMC material is malleable in the sense that it is capable of being custom shaped and fitted under moderate force, such as a force that ranges from light finger pressure to that applied with manual operation of a small hand tool, such as a dental composite instrument. An SMC material is curable in the sense that it can be cured using light, heat, pressure or the like. For dental applications, the material may be both partially curable to improve rigidity during certain handling steps, and fully curable to a hardness suitable for use as a dental article. The forgoing characteristics are now discussed in greater detail.

The term “self-supporting” as used herein means that an article is dimensionally stable and will maintain its preformed shape without significant deformation at room temperature (i.e., about 20° C. to about 25° C.) for at least two weeks when free-standing (i.e., without the support of packaging or a container). In many embodiments, the mill blanks and articles milled from uncured blanks are dimensionally stable at room temperature for at least one month, or for at least six months. In some embodiments, the mill blanks and articles milled from uncured mill blanks are dimensionally stable at temperatures above room temperature, or up to 40° C., or up to 50° C., or up to 60° C. This definition applies in the absence of conditions that activate any initiator system and in the absence of an external force other than gravity.

The terms “malleable” or having “sufficient malleability” as used herein in reference to SMC materials indicates that the material is capable of being custom-shaped and fitted onto a prepared tooth, or shaped into a suitable mill blank, under a moderate manual force (i.e., a force that ranges from light finger pressure to that applied with manual operation of a small hand tool, such as a dental composite instrument). The shaping, fitting, forming, etc., can be performed by adjusting the external shape and internal cavity shape of the SMC dental mill blank before, during, or after milling. In many embodiments, the SMC materials may exhibit the desired sufficient malleability at temperatures of, e.g., 40 degrees Celsius or less. In other instances, the SMC materials may exhibit “sufficient malleability” in a temperature range of, e.g., 15° C. to 38° C.

The terms “curable” or “hardenable” are used interchangeably herein to refer to materials that can be cured to lose their sufficient malleability. The hardenable (i.e., curable) materials may be irreversibly hardenable, which, as used herein, means that after hardening such that the composition loses its malleability it cannot be converted back into a malleable form without destroying the external shape of the resulting product. Examples of some potentially suitable hardenable compositions that may be used to construct the dental mill blanks described herein with sufficient malleability may include, e.g., hardenable organic compositions (filled or unfilled), polymerizable dental waxes, hardenable dental compositions having a wax-like or clay-like consistency in the unhardened state, etc. In some embodiments, the dental mill blanks are constructed of hardenable compositions that consist essentially of non-metallic materials.

Numerous SMC materials are described, for example in the following references, each of which is incorporated herein by reference: U.S. patent application Ser. No. 10/921,648 to Karim et al. entitled Hardenable Dental Article and Method of Manufacturing the Same, filed on Aug. 19, 2004 and published on May 12, 2005 as U.S. Pub. No. 2005/0100868; U.S. patent application Ser. No. 10/749,306 to Karim et. al. entitled Curable Dental Mill Blanks and Related Methods, filed on Dec. 31, 2003 and published on Jul. 7, 2005 as U.S. Pub. No. 2005/0147944; U.S. patent application Ser. No. 10/643,771 to Kvitrud et. al. entitled Dental Crown Forms and Methods, filed on Aug. 19, 2003 and published on Feb. 24, 2005 as U.S. Pub. No. 2005/0042577; U.S. patent application Ser. No. 10/643,748 to Oxman et. al. entitled Dental Article Forms and Methods, filed on Aug. 19, 2003 and published on Feb. 24, 2005 as U.S. Pub. No. 2005/0042576; U.S. patent application Ser. No. 10/219,398 to Karim et al. entitled Hardenable Self-Supporting Structures and Methods, filed on Aug. 15, 2002 and published on Jun. 19, 2003 as U.S. Pub. No. 2003/0114553; and International Patent Application No. US06/016197 to Karim et. al. entitled Malleable Symmetric Dental Crowns. In addition, 3M™, of St. Paul, Minn., markets a shell temporization made of SMC material under the trade name PROTEMP™ Crown. More generally, any material having self-supporting, malleable, curable characteristics suitable for use in the dental mill blanks described herein may be suitably employed.

A number of potentially suitable SMC materials are now described in greater detail.

With respect to certain of the hardenable compositions described above, the unique combination of highly malleable properties (preferably without heating above room temperature or body temperature) before hardening (e.g., cure) and high strength (preferably, e.g., a flexural strength of at least about 25 MPa) after hardening may provide preformed dental mill blanks with numerous potential advantages. For example, a preformed dental mill blank that is sufficiently malleable can facilitate forming of a desired mill blank shape before milling, or facilitate fitting of the milled or un-milled blank onto a prepared tooth surface during a fitting process. Because the compositions are hardenable, the adjusted external shape can also be retained permanently as desired. As described above, useful hardenable compositions for the SMC materials described herein may include e.g., polymerizable waxes, hardenable organic materials (filled or unfilled), etc. Some potentially suitable hardenable compositions may include those described in U.S. Pat. No. 5,403,188 to Oxman et al.; U.S. Pat. No. 6,057,383 to Volkel et al.); and U.S. Pat. No. 6,799,969 to Sun et al. The entire content of these references in incorporated by reference herein.

The SMC materials described above may include a resin system that includes a crystalline component, greater than 60 percent by weight (wt-%) of a filler system (preferably, greater than 70 wt-% of a filler system), and an initiator system, wherein the hardenable composition exhibits sufficient malleability to be formed onto a prepared tooth, preferably at a temperature of about 15° C. to 38° C. (more preferably, about 20° C. to 38° C., which encompasses typical room temperatures and body temperatures). In some embodiments, the hardenable compositions do not need to be heated above body temperature (or even above room temperature) to become malleable as discussed herein.

At least a portion of the filler system of a hardenable composition may include particulate filler. In this and various other embodiments, if the filler system includes fibers, the fibers may be present in an amount of less than 20 wt-%, based on the total weight of the composition.

The crystalline component may provide a morphology that assists in maintaining the self-supporting first shape. This morphology includes a noncovalent structure, which may be a three-dimensional network (continuous or discontinuous) structure. If desired, the crystalline component can include one or more reactive groups to provide sites for polymerizing or crosslinking. If such crystalline components are not present or do not include reactive groups, or optionally where crystalline components are present and do include reactive groups, such reactive sites may be provided by another resin component, such as an ethylenically unsaturated component.

Thus, for certain embodiments, the resin system includes at least one ethylenically unsaturated component. Ethylenically unsaturated components can be selected from the group consisting of mono-, di-, or poly-acrylates and methacrylates, unsaturated amides, vinyl compounds (including vinyl oxy compounds), and combinations thereof. This ethylenically unsaturated component can be the crystalline component or noncrystalline.

The crystalline component can include polyesters, polyethers, polyolefins, polythioethers, polyarylalkylenes, polysilanes, polyamides, polyurethanes, or combinations thereof. The crystalline component can include saturated, linear, aliphatic polyester polyols containing primary hydroxyl end groups. The crystalline component can optionally have a dendritic, hyperbranched, or star-shaped structure, for example.

The crystalline component can optionally be a polymeric material (i.e., a material having two or more repeat units, thereby including oligomeric materials) having crystallizable pendant moieties and the following general formula:

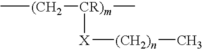

wherein R is hydrogen or a (C₁-C₄) alkyl group, X is —CH₂—, —C(O)O—, —O—C(O)—, —C(O)—NH—, —HN—C(O)—, —O—, —NH—, —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions.

Alternative to, or in combination with, the crystalline component, the hardenable composition can include a filler that is capable of providing a morphology to the composition that includes a noncovalent structure, which may be a three-dimensional network (continuous or discontinuous) structure, that assists in the maintenance of the first shape. In some embodiments, such a filler has nanoscopic particles, or the filler is an inorganic material having nanoscopic particles. To enhance the formation of the noncovalent structure, the inorganic material can include surface hydroxyl groups. In some embodiments, the inorganic material includes fumed silica.

In some embodiments, the composition includes, in addition to a resin system and an initiator system, either a crystalline component or a filler system that includes a particulate filler (e.g, a micron-size particulate filler, a nanoscopic particulate filler, a colloidal or fumed filler, a prepolymerized organic filler, or any combination of these), or both a crystalline component and a filler system. Furthermore, the use of one or more surfactants may also enhance the formation of such a noncovalent structure, and a surfactant system may optionally be employed. As used herein, a filler system includes one or more fillers and a surfactant system includes one or more surfactants.

Another potential embodiment may include a hardenable composition that includes a resin system, a filler system at least a portion of which is an inorganic material having nanoscopic particles with an average primary particle size of no greater than about 50 nanometers (nm), a surfactant system, and an initiator system. The hardenable composition can exhibit sufficient malleability to be formed onto a prepared tooth at a temperature of about 15° C. to 38° C. In embodiments with a surfactant system and nanoscopic particles, the resin system can include at least one ethylenically unsaturated component, and the filler system is present in an amount of greater than 50 wt-%.

In other embodiments, hardenable compositions may include a resin system that includes: a noncrystalline component selected from the group consisting of mono-, di-, or poly-acrylates and methacrylates, unsaturated amides, vinyl compounds, and combinations thereof; and a crystalline component selected from the group consisting of polyesters, polyethers, polyolefins, polythioethers, polyarylalkylenes, polysilanes, polyamides, polyurethanes, polymeric materials (including oligomeric materials) having crystallizable pendant moieties and the following general formula:

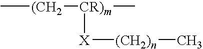

wherein R is hydrogen or a (C₁-C₄) alkyl group, X is —CH₂—, —C(O)O—, —O—C(O)—, —C(O)—NH—, —HN—C(O)—, —O—, —NH—, or —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions, and combinations thereof. The hardenable composition may further include greater than about 60 wt-% of a filler system and an initiator system. The hardenable composition can exhibit sufficient malleability to be formed onto a prepared tooth at a temperature of about 15° C. to 38° C. If the filler system includes fibers, the fibers may be present in an amount of less than 20 wt-%, based on the total weight of the hardenable composition.

In yet another embodiment, the hardenable compositions includes a resin system with a crystalline compound of the formula:

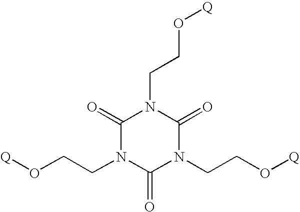

wherein each Q independently comprises polyester segments, polyamide segments, polyurethane segments, polyether segments, or combinations thereof; a filler system; and an initiator system.

The SMC material may include organogelators and polymerizable components that can be used in a variety of dental applications.

In one embodiment, the SMC material includes a polymerizable component, an organogelator, and a crystalline material. In another embodiment, the SMC material includes a hardenable dental composition that includes a polymerizable component, an organogelator, and 60% or more filler material. In another embodiment, the SMC material includes a hardenable dental composition that includes a polymerizable component, an organogelator, and filler material comprising nanoscopic particles. In another embodiment, the SMC material includes a hardenable dental composition that includes a polymerizable component and a polymerizable organogelator.

In certain embodiments, the hardenable composition can be in the form of a hardenable, self-supporting (i.e., free-standing) structure having a first shape. The self-supporting structure has sufficient malleability to be reformed into a second shape, thereby providing for simplified customization of a device, e.g., simplified customized fitting of a dental prosthetic device. Once reformed into a second shape, the composition can be hardened using, for example, a free radical curing mechanism under standard photopolymerization conditions to form a hardened composition with improved mechanical properties. Significantly, for certain embodiments of the compositions described herein, the hardened structure does not need an additional veneering material.

In certain embodiments, the hardenable composition includes an organogelator of the general formula (Formula I):

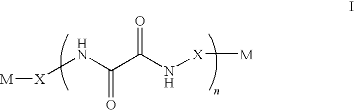

wherein each M is independently hydrogen or a polymerizable group; each X is independently an alkylene group, cycloalkylene group, arylene group, arenylene group, or a combination thereof, and n is 1 to 3. Such organogelators are also provided by the present invention.

Herein, an “organogelator” is a generally low molecular weight organic compound (generally no greater than 3000 g/mol) that forms a three-dimensional network structure when dissolved in an organic fluid, thereby immobilizing the organic fluid and forming a non-flowable gel that exhibits a thermally reversible transition between the liquid state and the gel state when the temperature is varied above or below the gel point of the mixture.

Herein, the “polymerizable component” can include one or more resins, each of which can include one or more monomers, oligomers, or polymerizable polymers.

The compositions described herein have numerous potential applications, including use in fabricating a number of the dental articles described above. These applications include, but are not limited to, dental restoratives and dental prostheses, including, but not limited to, temporary, intermediate/interim, and permanent crowns and bridges, inlays, onlays, veneers, implants, abutments for implants, core build-ups, dentures, and artificial teeth, as well as dental impression trays, orthodontic appliances (e.g., retainers, night guards), orthodontic adhesives, tooth facsimiles or splints, maxillofacial prostheses, and other customized structures.

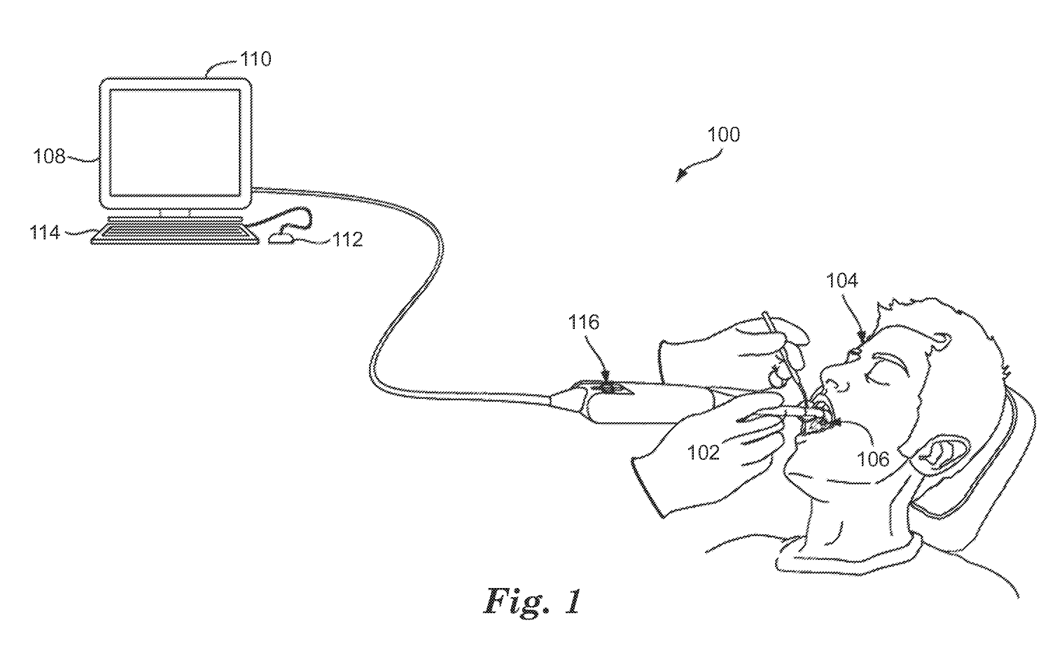

FIG. 1 shows a three-dimensional scanning system that may be used with the systems and methods described herein. In general, the system 100 may include a scanner 102 that captures images from a surface 106 of a subject 104, such as a dental patient, and forwards the images to a computer 108, which may include a display 110 and one or more user input devices such as a mouse 112 or a keyboard 114. The scanner 102 may also include an input or output device 116 such as a control input (e.g., button, touchpad, thumbwheel, etc.) or a display (e.g., LCD or LED display) to provide status information.

The scanner 102 may include any camera or camera system suitable for capturing images from which a three-dimensional point cloud may be recovered. For example, the scanner 102 may employ a multi-aperture system as disclosed, for example, in U.S. patent application Ser. No. 11/530,413 to Rohály et al. entitled Monocular Three-Dimensional Imaging, the entire content of which is incorporated herein by reference. While Rohály discloses certain multi-aperture systems, it will be appreciated that any multi-aperture system suitable for reconstructing a three-dimensional point cloud from a number of two-dimensional images may similarly be employed. In one multi-aperture embodiment, the scanner 102 may include a plurality of apertures including a center aperture positioned along a center optical axis of a lens, along with any associated imaging hardware. The scanner 102 may also, or instead, include a stereoscopic, triscopic or other multi-camera or other configuration in which a number of cameras or optical paths are maintained in fixed relation to one another to obtain two-dimensional images of an object from a number of slightly different perspectives. The scanner 102 may include suitable processing for deriving a three-dimensional point cloud from an image set or a number of image sets, or each two-dimensional image set may be transmitted to an external processor such as contained in the computer 108 described below. In other embodiments, the scanner 102 may employ structured light, laser scanning, direct ranging, or any other technology suitable for acquiring three-dimensional data, or two-dimensional data that can be resolved into three-dimensional data.

In one embodiment, the scanner 102 is a handheld, freely positionable probe having at least one user input device 116, such as a button, lever, dial, thumb wheel, switch, or the like, for user control of the image capture system 100 such as starting and stopping scans. In an embodiment, the scanner 102 may be shaped and sized for dental scanning. More particularly, the scanner may be shaped and sized for intraoral scanning and data capture, such as by insertion into a mouth of an imaging subject and passing over an intraoral surface 106 at a suitable distance to acquire surface data from teeth, gums, and so forth. The scanner 102 may, through such a continuous acquisition process, capture a point cloud of surface data having sufficient spatial resolution and accuracy to prepare dental objects such as prosthetics, hardware, appliances, and the like therefrom, either directly or through a variety of intermediate processing steps. In other embodiments, surface data may be acquired from a dental model such as a dental prosthetic, to ensure proper fitting using a previous scan of corresponding dentition, such as a tooth surface prepared for the prosthetic.

Although not shown in FIG. 1, it will be appreciated that a number of supplemental lighting systems may be usefully employed during image capture. For example, environmental illumination may be enhanced with one or more spotlights illuminating the subject 104 to speed image acquisition and improve depth of field (or spatial resolution depth). The scanner 102 may also, or instead, include a strobe, flash, or other light source to supplement illumination of the subject 104 during image acquisition.

The subject 104 may be any object, collection of objects, portion of an object, or other subject matter. More particularly with respect to the dental fabrication techniques discussed herein, the object 104 may include human dentition captured intraorally from a dental patient's mouth. A scan may capture a three-dimensional representation of some or all of the dentition according to a particular purpose of the scan. Thus the scan may capture a digital model of a tooth, a quadrant of teeth, or a full collection of teeth including two opposing arches, as well as soft tissue or any other relevant intraoral structures. In other embodiments where, for example, a completed fabrication is being virtually test fit to a surface preparation, the scan may include a dental prosthesis such as an inlay, a crown, or any other dental prosthesis, dental hardware, dental appliance, or the like. The subject 104 may also, or instead, include a dental model, such as a plaster cast, wax-up, impression, or negative impression of a tooth, teeth, soft tissue, or some combination of these.

The computer 108 may be, for example, a personal computer or other processing device. In one embodiment, the computer 108 includes a personal computer with a dual 2.8 GHz Opteron central processing unit, 2 gigabytes of random access memory, a TYAN Thunder K8WE motherboard, and a 250 gigabyte, 10,000 rpm hard drive. This system may be operated to capture approximately 1,500 points per image set in real time using the techniques described herein, and store an aggregated point cloud of over one million points. As used herein, the term “real time” means generally with no observable latency between processing and display. In a video-based scanning system, real time more specifically refers to processing within the time between frames of video data, which may vary according to specific video technologies between about fifteen frames per second and about thirty frames per second. More generally, processing capabilities of the computer 108 may vary according to the size of the subject 104, the speed of image acquisition, and the desired spatial resolution of three-dimensional points. The computer 108 may also include peripheral devices such as a keyboard 114, display 110, and mouse 112 for user interaction with the camera system 100. The display 110 may be a touch screen display capable of receiving user input through direct, physical interaction with the display 110.

Communications between the computer 108 and the scanner 102 may use any suitable communications link including, for example, a wired connection or a wireless connection based upon, for example, IEEE 802.11 (also known as wireless Ethernet), BlueTooth, or any other suitable wireless standard using, e.g., a radio frequency, infrared, or other wireless communication medium. In medical imaging or other sensitive applications, wireless image transmission from the scanner 102 to the computer 108 may be secured. The computer 108 may generate control signals to the scanner 102 which, in addition to image acquisition commands, may include conventional camera controls such as focus or zoom.

In an example of general operation of a three-dimensional image capture system 100, the scanner 102 may acquire two-dimensional image sets at a video rate while the scanner 102 is passed over a surface of the subject. The two-dimensional image sets may be forwarded to the computer 108 for derivation of three-dimensional point clouds. The three-dimensional data for each newly acquired two-dimensional image set may be derived and fitted or “stitched” to existing three-dimensional data using a number of different techniques. Such a system employs camera motion estimation to avoid the need for independent tracking of the position of the scanner 102. One useful example of such a technique is described in commonly-owned U.S. patent application Ser. No. 11/270,135 to Zhang et al. entitled Determining Camera Motion filed on Nov. 8, 2005 and published on May 10, 2007 as U.S. Pub. No. 2007/0103460, the entire content of which is incorporated herein by reference. However, it will be appreciated that this example is not limiting, and that the principles described herein may be applied to a wide range of three-dimensional image capture systems.

The display 110 may include any display suitable for video or other rate rendering at a level of detail corresponding to the acquired data. Suitable displays include cathode ray tube displays, liquid crystal displays, light emitting diode displays and the like. In some embodiments, the display may include a touch screen interface using, for example capacitive, resistive, or surface acoustic wave (also referred to as dispersive signal) touch screen technologies, or any other suitable technology for sensing physical interaction with the display 110.

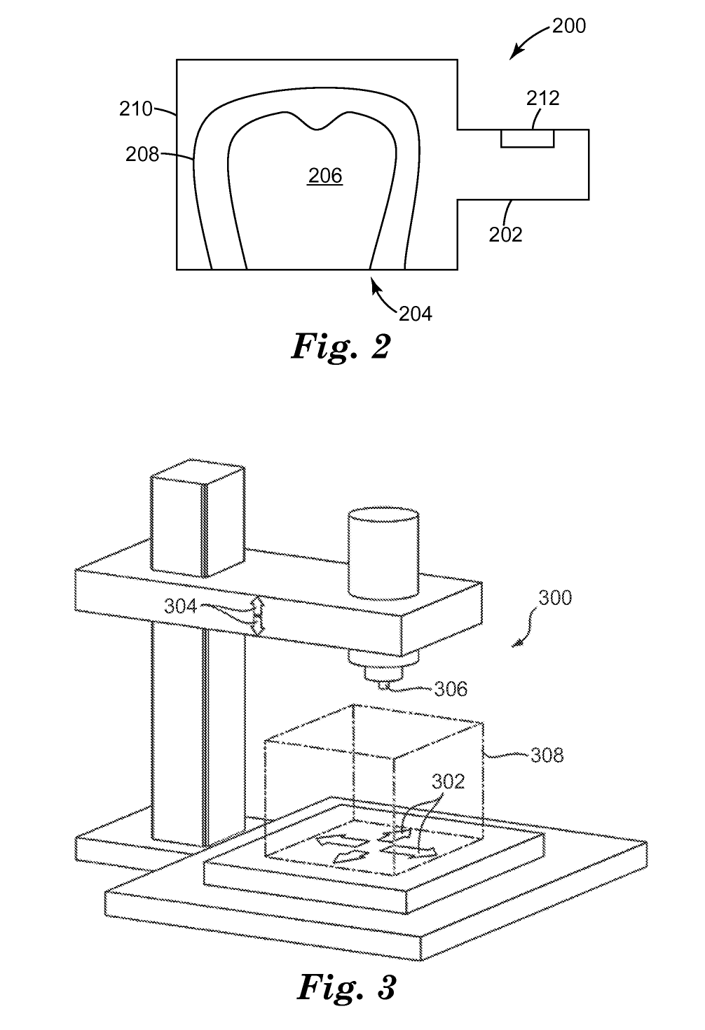

FIG. 2 shows an SMC dental mill blank that may be used with the systems and methods described herein. FIG. 2 shows a side view cross section of a compound dental mill blank. In general, a compound dental mill blank 200 includes a stem 202 and a body 204 that includes a volume encompassing an internal material 206, an exterior material 208, and an outer layer 210. The dental mill blank 200 may also optionally include an identifier 212 such as a bar code or Radio-Frequency Identification (RFID) tag. It will be understood that while compound SMC mill blanks are described below, and while certain advantages may be realized using compound SMC mill blanks, a mill blank formed from a single SMC material, or an SMC material and some other material, may also or instead be suitably employed with the systems and methods described herein.

The stem 202 may optionally be provided to support the blank 200 during milling or other handling, and may be shaped to fit into a corresponding chuck or other support of a milling machine or similar hardware for shaping the blank 200 through the selective removal of material therefrom. In some embodiments, the stem 202 may be cured prior to milling for improved mechanical support of the blank 200.

The body 204 may have any shape and size suitable for accommodating the internal material 206 and exterior material 208 as described below, and may further include an optional outer layer 210 as described generally below. It will be understood that the blank 200 may be selected or fabricated to match a predetermined tooth size, as determined for example by direct measurement of a site for which a restoration or the like is to be fabricated.

The internal material 206 may be any of the SMC materials described above. The internal material 206 may be spatially distributed within the dental mill blank in a manner substantially corresponding to a distribution, in a cured and milled dental article fabricated from the blank 200, of dentin in a natural tooth structure. This distribution may vary according to the size or type of tooth for which a dental article is to be milled. For example, for a restoration the distribution may vary according to whether the restoration is a crown, a bridge, an inlay, an onlay, or a veneer. The internal material 206 may be selected to achieve one or more optical properties similar or identical to dentin in a dental article milled from the blank 200. Thus for example the internal material 206 may be selected to have a translucence, color, or shade similar or identical to that of dentin, or may be selected to provide an appearance in the resulting restoration of the desired optical property or properties. Similarly, the internal material 206 may be selected to achieve on or more mechanical (i.e., structural) properties similar or identical to dentin in a cured dental article milled from the blank 200. Thus for example the internal material 206 may be selected to support a tooth structure in ordinary use, or more generally to provide a desired degree of resistance to fracture, hardness, pliability or the like to a core region of a restoration. In particular, these characteristics may be selected to match the corresponding mechanical properties of a natural tooth structure in a cured dental article fabricated from the blank 200.

The exterior material 208 may be any of the SMC materials described above. The exterior material 208 may be spatially distributed within the dental mill blank in a manner substantially corresponding to a distribution, in a cured and milled dental article fabricated from the blank 200, of enamel in a natural tooth structure. While the interior surface of this material 208 is defined by a mating exterior surface of the internal material 206, the exterior surface of the exterior material 208 may extend as appropriate to provide a required buffer for milling on all surfaces. The exterior material 208 may optionally extend to the extent of the body 204, thus omitting any separate outer layer 210 from the mill blank. The distribution of the exterior material 208 may vary according to the size or type of tooth for which a dental article is to be milled. For example, for a restoration the distribution may vary according to whether the restoration is a crown, a bridge, an inlay, an onlay, or a veneer. The exterior material 208 may be selected to achieve one or more optical properties similar or identical to enamel in a dental article milled from the blank 200. Thus for example the exterior material 208 may be selected to have a translucence, color, or shade similar or identical to that of enamel, or may be selected to provide an appearance in the resulting restoration of the desired optical property or properties. Similarly, the exterior material 208 may be selected to achieve on or more mechanical (i.e., structural) properties similar or identical to enamel in a cured dental article milled from the blank 200. Thus for example the exterior material 208 may be selected to provide a desired hardness, chip resistance, stain resistance, wear resistance, polish retention, and the like to an external surface of a restoration. In particular, these characteristics may be selected to match the corresponding mechanical properties of a natural tooth structure in a cured dental article fabricated from the blank 200.

It will be understood that, while the distribution of materials may be carefully controlled to achieve a distribution more exactly corresponding to a distribution of enamel and dentin in a natural tooth structure, this distribution may be varied according to the capability of particular SMC materials to match the aesthetic and structural properties of the tooth structure being replaced. Thus while at a high level the distribution should result in the exterior material 208 appearing on external surfaces of a milled dental article and an internal material within a majority of the volume of the milled dental article, the foregoing description should not be construed to require a precise match between the distribution of SMC materials in the mill blank 200 and the distribution of enamel and dentin in a natural tooth structure.

The outer layer 210 may optionally be provided to serve any number of auxiliary functions. This may include, for example, shaping the blank 200 for convenient handling, packaging, or shipping, as well as protecting the interior of the blank prior to milling, such as to avoid unwanted deformation during stacking or substantial temperature excursions. The outer layer 210 may be millable, or otherwise removable from the blank 200 prior to milling.

The mill blank 200 may optionally include an identifier 212. The identifier 212 may be a bar code, RFID tag, or other identifier that uniquely identifies the blank 200 or associates the blank 200 with one or more properties. The identifier 212 may, for example, be a bar code, serial number, or other human-readable or machine-readable indicia on an exterior surface of the blank 200. The identifier 212 may also be affixed to packaging for the blank 200. The identifier 212 may also, or instead, include an RFID tag or the like physically embedded within the blank 200. In these latter embodiments, the RFID tag may be positioned in a portion of the blank, such as the outer layer 210, that is intended to be removed by milling, or the RFID tag may be positioned within the internal material 206 so that a restoration or other dental article fabricated from the blank 200 carries the information within the RFID tag. In one embodiment, the identifier 212 may encode a unique identification number for the blank 200. This number may be used to obtain any information cross-referenced to that unique number, which may include data concerning the spatial distribution of SMC materials, the size, shade, and type of SMC materials or dental articles milled therefrom, and any other data useful to a dentist preparing a dental article from the mill blank 200, or useful to a machine such as a computer-controlled milling machine that operates on the mill blank 200. In another aspect, the identifier 212 may directly encode data concerning the blank such as a batch number, a shape, a shelf life, and so forth. More generally, any information useful for handling or using the blank 200 may be encoded directly within the identifier 212, or obtained using a unique identifier encoded within the identifier 212. It will be appreciated that the identifier 212 may also, or instead, encode non-unique information that is in turn used to obtain relevant data for the blank 200. All such variations to and combinations of the foregoing are intended to fall within the scope of this disclosure.

FIG. 3 shows a milling machine that may be used with the systems and methods herein. In particular, FIG. 3 illustrates a Computerized Numerically Controlled (“CNC”) milling machine 300 including a table 302, an arm 304, and a cutting tool 306 that cooperate to mill under computer control within a working envelope 308. In operation, a workpiece (not shown) may be attached to the table 302. The table 302 may move within a horizontal plane and the arm 304 may move on a vertical axis to collectively provide x-axis, y-axis, and z-axis positioning of the cutting tool 306 relative to a workpiece within the working envelope 308. The cutting tool 306 may thus be maneuvered to cut a computer-specified shape from the workpiece.

Milling is generally a subtractive technology in that material is subtracted from a block rather than added. Thus pre-cut workpieces approximating commonly milled shapes may advantageously be employed to reduce the amount of material that must be removed during a milling job, which may reduce material costs and/or save time in a milling process. More specifically in a dental context, it may be advantageous to begin a milling process with a precut piece, such as a generic coping, rather than a square block. A number of sizes and shapes (e.g., molar, incisor, etc.) of preformed workpieces may be provided so that an optimal piece may be selected to begin any milling job. Various milling systems have different degrees of freedom, referred to as axes. Typically, the more axes available (such as 4-axis milling), the more accurate the resulting parts. High-speed milling systems are commercially available, and can provide high throughputs.

In addition a milling system may use a variety of cutting tools, and the milling system may include an automated tool changing capability to cut a single part with a variety of cutting tools. In milling a dental model, accuracy may be adjusted for different parts of the model. For example, the tops of teeth, or occlusal surfaces, may be cut more quickly and roughly with a ball mill and the prepared tooth and dental margin may be milled with a tool resulting in greater detail and accuracy.

All such milling systems as may be adapted for use with the dental mill blanks 200 described herein are intended to fall within the scope of the term “milling” as used herein, and a milling process may employ any such milling systems. More generally, as used herein “milling” may refer to any subtractive process including abrading, polishing, controlled vaporization, electronic discharge milling (EDM), cutting by water jet or laser or any other method of cutting, removing, shaping or carving material, unless a different meaning is explicitly provided or otherwise clear from the context. Inputs to the milling system may be provided from three-dimensional scans of dentition using, e.g., the scanner 102 of FIG. 1, three-dimensional scans of working models (which may also be created from a three-dimensional scan), CAD/CAM models (which may also be derived from a three-dimensional scan), or any other suitable source. It should be further understood that, while milling is one example of a digitally-subtractive technique, and a computer-controlled milling machine is a readily commercially available digitally-subtractive device, that other techniques for removing material under computer control are also known, and may be suitably adapted to use as a digitally-subtractive method or system as disclosed herein. This includes, for example, cutting, skiving, sharpening, lathing, abrading, sanding, and the like. Such uses are intended to fall within the scope of this disclosure.

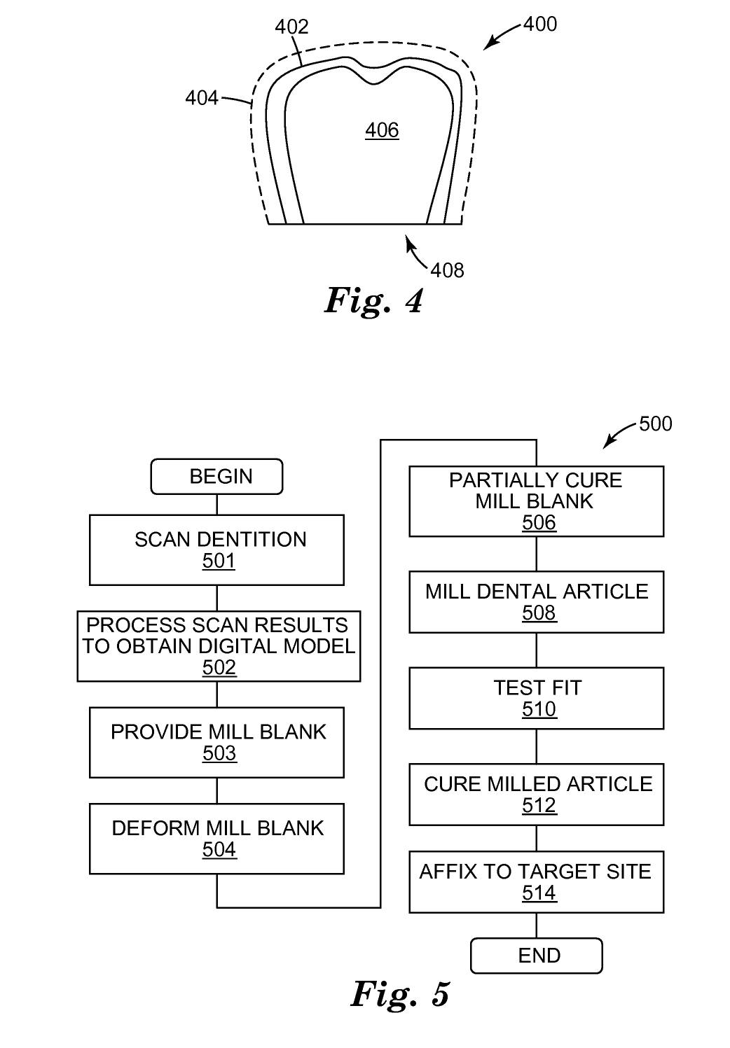

FIG. 4 shows a dental article fabricated from a dental mill blank according to the systems and methods described herein. The dental article 400, which may be a crown or the like, may have an exterior surface 402 milled from the exterior material 208 of the mill blank 200 of FIG. 2. The exterior surface 402 may, in general, match the appearance and function of enamel in a natural tooth structure that the dental article 400 is intended to replace. An appropriate shape may be imparted to the exterior surface 402 using any of the subtractive milling techniques described above. The envelope 404 of the exterior material 208 from the mill blank 200 is also shown for reference, although it does not form a part of the structure in FIG. 4. An interior structure 406 may be formed of the internal material 206 of the mill blank 200 of FIG. 2, and may in general provide structural support for the dental article 400. While a bottom surface 408 of the article 400 is depicted as a flat surface, it will be understood that in general the bottom surface 408 will be shaped to match a prepared tooth surface where the dental article 400 is to be affixed within human dentition.

As noted above with reference to FIG. 2, while a compound mill blank is shown and described, a monolithic SMC mill blank may similarly be used with the systems and methods described herein, or a mill blank having a single SMC material along with one or more other materials, or some combination of these. In practice, the dental article 400 may be subjected to a variety of finish steps including polishing, curing, drying, adjusting, sealing, and coating with a variety of finishes for improved look or function.

FIG. 5 shows a method for fabricating a dental article from an SMC dental mill blank.

The process 500 may begin by scanning dentition as shown in step 501. This may include an acquisition of a three-dimensional surface representation or other digital model of a patient's dentition using, e.g., the scanning system described above with reference to FIG. 1. Where a tooth surface is prepared to receive a restoration or the like, step 501 may include a scan before preparation to capture the original, natural shape of the tooth structure being replaced. Step 501 may also, or instead, include a scan of the prepared tooth surface, which may be used in subsequent steps to fabricate a mating, bonding surface of a dental article. Step 501 may also, or instead, include a scan of surrounding dentition including, for example, an opposing arch, neighboring teeth, soft tissue, and the like, any of which might be usefully employed in computer-assisted design of a dental article for the prepared tooth surface.

As shown in step 502, the scan results from step 501 may be processed to obtain a digital model for a computer-controlled milling machine. This may include a wide array of modeling steps. For example, a preliminary or final digital model may be obtained through superposition of pre- and post-preparation scans of a tooth surface, thus permitting the direct fabrication of a replacement article that corresponds physically to the removed structure. A number of dental CAD tools also exist that may be used to create models for restorations and the like from preliminary scan-based models, or from generic tooth models and the like in a dental CAD model library or the like. In addition, some combination of these techniques may be employed.

In one aspect, the model may be adjusted to compensate for shrinkage that occurs during curing of SMC materials. SMC materials may shrink in predictable manners during curing. For example, for light-based curing, monolithic shrinkage in the range of 2% (depending, of course, upon the particular materials) might be expected, provided the light fully penetrates an article that is being cured. Under such conditions, the digital model may be linearly expanded in all dimensions, so that a resulting cured article matches, e.g., an actual prepared tooth surface within a dental patient's dentition. More complex shrinkage algorithms may be required where, for example, articles are partially cured (with respect to degree of curing or location of curing) during handling, or where curing is initiated at a surface of an article. Creating and applying suitable algorithms is within the skill of one of ordinary skill in the relevant arts.

Once a digital model has been obtained, a mill blank may be provided, as shown in step 503. The mill blank may be any of the mill blanks described above including monolithic SMC mill blanks, compound SMC dental mill blanks, or other mill blanks incorporating SMC materials. The mill blank may be selected using any of the criteria described above including, for example, the shape of a desired restoration, the size of a tooth being restored, the type of tooth being restored, and optical characteristics such as color, shade, opacity, and so forth. These criteria may be objectively determined using image analysis including computerized review of image/video data to determine optical and aesthetic properties for a dental article. Image analysis may also or instead include dimensional analysis of three-dimensional data to determine a size, shape, type, or other physical characteristics of the dental article. These criteria may also, or instead, be subjectively determined by a dental professional such as during a patient visit. In one aspect, a suitable mill blank may be selected using a bar code, RFID tag, or other identifier attached to or imprinted on the mill blank.

As shown in step 504, the mill blank may be deformed. This may be, for example, a controlled deformation to adapt the mill blank to a specific tooth structure of a dental patient, such as by adapting the mill blank to a particular tooth shape or size. As a significant advantage, this technique may permit a significant reduction in the types of mill blanks required for a range of restorations and other dental procedures. Deformation may be performed, for example, by direct manual deformation of the blank by a dental professional or technician, or using a tool or machine adapted to apply incremental changes along a dimension such as the height or width of the mill blank.

As shown in step 506, the blank may be partially cured. This may include, for example, curing to preserve the deformation applied in step 504 during milling, or more generally curing the blank to prepare for milling. This may also include partial spatial curing, such as curing the stem or other support structures for the mill blank. It will be appreciated that such interim curing steps are optional, and will depend on the particular milling procedure and SMC materials being used, as well as the dental article being fabricated.

As shown in step 508, the mill blank may then be milled into a dental article using any of the milling techniques described above. As generally noted above, the milled dental article may be a restoration such as a crown, a bridge, an inlay, an onlay, a veneer, and the like, as well as any other dental article that replaces natural dentition. For example, the techniques described herein may be suitably adapted to the manufacture of a prosthesis such as a denture or implant.

As shown in step 510, the milled dental article may be test fit to a site in a patient's dentition. This may be performed directly on a patient's dentition, or using a dental model, an articulator, or the like. So for example, the dental article may be placed into an articulating model, and manual adjustments may be made to static or dynamic occlusal fit. Any number of test fits may be performed, after which manual adjustments or re-milling may be performed to adjust occlusal fit, proximal contacts, and the like or otherwise reshape the dental article to obtain a desired exterior shape.

As shown in step 512, once an adequate fit has been achieved the article may be cured to final hardness. Additional reshaping and fitting may be performed after curing to final hardness.

As shown in step 514, the milled, shaped, and cured article may be permanently affixed to a target site in a patient's dentition such as by adhering the article using any number of suitable dental adhesives. Additional reshaping and fitting may be performed after affixing to the target site, for example in response to patient observations concerning fit.

It will be understood that the above process 500 is merely exemplary. Any number of adaptations may be made, and steps may be added or removed from the process 500 as described. For example, in one aspect, the entire dental article may be retained in an at least partially uncured state until the article is permanently affixed to a target site. This technique usefully permits a degree of deformation of the dental article to more closely mate with a prepared tooth surface or surrounding dentition. In another aspect, the entire article except for the portion mating to a prepared tooth surface may be fully cured, with malleability preserved at the mating surface to achieve a closer final fit. In another aspect, the article may be fully cured after milling, with subsequent adjustments performed in a conventional fashion with dental grinding tools. All such variations as would be clear to one of ordinary skill in the art are intended to fall within the scope of this disclosure.

It will be appreciated that various aspects of the methods described above may be realized in hardware, software, or any combination of these suitable for the data acquisition and fabrication technologies described herein. This includes realization in one or more microprocessors, microcontrollers, embedded microcontrollers, programmable digital signal processors or other programmable devices, along with internal and/or external memory. The realization may also, or instead, include one or more application specific integrated circuits, programmable gate arrays, programmable array logic components, or any other device or devices that may be configured to process electronic signals. It will further be appreciated that a realization may include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the scanning device, milling machine, and so forth in a number of ways or all of the functionality may be integrated into a dedicated, standalone device. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

What is claimed is:

1. A method comprising:
providing a dental mill blank comprising a self-supporting, malleable, curable (SMC) material;
scanning dentition to obtain a scan result;
processing the scan result to obtain a three-dimensional digital model for controlling a digitally-controlled milling machine;
fabricating a dental article from the dental mill blank using the three-dimensional digital model and the digitally-controlled milling machine; and
curing the dental article to provide a cured dental article.

2. The method of claim 1 further comprising adjusting the three-dimensional digital model to compensate for shrinkage to the dental article during curing.

3. The method of claim 2 wherein adjusting the three-dimensional digital model includes compensating for monolithic shrinkage.

4. The method of claim 1 further comprising securing the cured dental article to a prepared tooth surface.

5. The method of claim 1 further comprising securing the dental article to a prepared tooth surface before curing the dental article.

6. The method of claim 5 further comprising adjusting one or more proximal contacts of the dental article before curing the dental article.

7. The method of claim 1 wherein scanning dentition includes scanning a tooth surface before preparation of the surface for the dental article.

8. The method of claim 7 further comprising creating at least one surface of the three-dimensional digital model using the scan of the tooth surface.

9. The method of claim 1 wherein scanning dentition includes scanning a prepared tooth surface.

10. The method of claim 9 further comprising creating at least one surface of the three-dimensional digital model using the scan of the prepared tooth surface.

11. The method of claim 1 further comprising manually reshaping the dental article to obtain a desired exterior surface for the dental article.

12. The method of claim 1 further comprising placing the cured dental article into an articulating model and adjusting an occlusal fit of the cured dental article.

13. The method of claim 1 further comprising placing the dental article into an articulating model and adjusting an occlusal fit of the dental article before curing.

14. The method of claim 1 wherein the SMC material includes a resin system with a crystalline component, a filler system, and an initiator system.

15. The method of claim 1 wherein the SMC material includes:
a resin system comprising at least one ethylenically unsaturated component and a crystalline component;
greater than 60 wt-% of a filler system; and
an initiator system;
wherein the SMC material exhibits sufficient malleability at a temperature of about 15° C. to 38° C.

16. The method of claim 1 wherein the SMC material includes a polymerizable compound and an organogelator.

17. The method of claim 16 wherein the organogelator is a polymerizable organogelator.

18. The method of claim 1 further comprising partially curing the dental article to provide a partially cured dental article and manually reshaping the partially cured dental article to obtain a desired exterior shape.

19. The method of claim 1 wherein the dental article includes a restoration.

20. The method of claim 19 wherein the restoration includes a dental article selected from the group consisting of a bridge, a crown, an inlay, and an onlay.
